(19) United States
(12) Patent Application Publication
(10) Pub. No.: US 2024/0128662 A1
(43) Pub. Date: Apr. 18, 2024

(54) ELECTRICAL CONNECTOR FOR ELECTRICALLY CONDUCTIVE STRIP AND ASSEMBLY FOR HEATING STRUCTURE

(71) Applicant: VALEO SYSTEMES THERMIQUES, La Verriere (FR)

(72) Inventors: Nicolas DEVIENNE, La Verriere (FR); Alexandre PASCHUTINE, La Verriere (FR); Jerome DAUBA, La Verriere (FR); Alexandre WEIL, La Verriere (FR); Vincent FEUILLARD, La Verriere (FR)

(73) Assignee: VALEO SYSTEMES THERMIQUES, La Verriere (FR)

(21) Appl. No.: 18/547,788

(22) PCT Filed: Feb. 21, 2022
(86) PCT No.: PCT/EP2022/054292

§ 371 Date: Aug. 24, 2023

(30) Foreign Application Priority Data
Feb. 24, 2021 (FR) 2101777

(51) Int. Cl. H01R 4/48; H01R 12/63

(52) U.S. Cl. CPC H01R 4/48; H01R 12/63

(57) ABSTRACT

An assembly including an electrically conductive strip extending along a longitudinal axis, including a first carrier layer having a first face and a second face opposite the first face; a first electrically conductive track placed on the first face or the second face of the first carrier layer; an electrical connector with a first clamping portion and a second clamping portion that are securely fastened to each other and that define a clamping region for clamping the electrically conductive strip. The first and second clamping portions clamp the electrically conductive strip. At least one of the first and second clamping portions includes a first contact segment making electrical contact with the first electrically conductive track.

### TECHNICAL FIELD

The present invention relates to the field of heating structures intended to equip the interior of a vehicle, a motor vehicle for example. The invention more particularly relates to an electrical connector for an electrically conductive strip belonging to such heating structures. The invention also relates to an assembly comprising an electrical connector and an electrically conductive strip intended to supply electrical power to a heating structure, such as a radiant panel.

### BACKGROUND OF THE INVENTION

Various types of metal connectors intended to connect an electrical power supply and an electrically conductive part have been described in the prior art. These connectors cover various applications such as automotive or domestic applications.

Document U.S. Pat. No. 3,753,204 A describes a solution for connecting two coaxial metal cables by means of an electrical conductor assembly involving a screw. The proposed solution is inappropriate when it is a question of bringing into mechanical and electrical contact two parts one of which is particularly thin, soft, flexible and of high area-to-volume ratio. Specifically, a screw does not hold two such parts together effectively in the two directions parallel to the plane formed by the part of high area-to-volume ratio. Furthermore, such a connector is particularly bulky and creates bulges, this potentially adversely affecting the haptics of the electrically conductive strip, in particular when it is a question of integrating it into a heating structure such as a radiant panel that must be as discreet as possible.

The document FR 3099005 A1 describes a space-saving connector configured to form electrical contacts over the entire width of a pliable conductive strip with improved haptics. Connection is made via a plurality of point contacts formed using connecting teeth that occupy at least 90% of the width of the conductive track, this ensuring a good electric current distribution. The connecting teeth create through-vias in the conductive strip by punching through the carrier layer and the conductive track of said strip, this weakening the conductive strip and leading to a risk of the associated heating-structure assembly tearing.

Mention can also be made of solutions for connecting pliable surfaces by way of individual contacts, which solutions are designed to connect a plurality of low-power circuits at the same time. Electrical contact is made in a pointwise manner, especially via a clip clamping a track of the printed circuit, or via flat cables, or even via a crimped contact of small size. However, these connection solutions remain incompatible with high powers.

One of the objectives of the present invention is therefore to remedy the drawbacks of the prior art by providing a connector, for an electrically conductive strip intended to equip a heating structure such as a motor-vehicle radiant panel, that has a small bulk (required to obtain good haptics) while guaranteeing the connector assembly—electrically conductive strip retains solidity and robustness.

### SUMMARY OF THE INVENTION

To this end, one subject of the invention is an electrical connector for an electrically conductive strip extending along a longitudinal axis, the electrically conductive strip comprising:
a carrier layer having a first face and a second face opposite the first face,
at least one electrically conductive track placed on the first face and/or the second face of the carrier layer,
said electrical connector comprising first and second clamping portions that are securely fastened to each other and that define a clamping region for clamping the electrically conductive strip,
at least one of the first and second clamping portions comprising at least one contact segment making contact with said at least one electrically conductive track,
the first and second clamping portions being configured to clamp the electrically conductive strip and to make electrical contact between said at least one electrically conductive track and the at least one of the first and second clamping portions.

Thus, advantageously, this connector makes linear and continuous electrical contact by clamping an electrically conductive strip on each of its faces. Current is advantageously distributed over the whole width of an electrically conductive track of the strip. Lastly, electrical contact is ensured without it being necessary to pierce the thickness of the carrier layer and of the electrically conductive track. This thus limits creation of regions of fragility and of breakage of lines of current flow within the materials from which the electrically conductive strip is formed. This is particularly advantageous when the carrier layer consists of a flexible material that can easily undergo tearing, such as a textile, and when the electrically conductive track consists of a particularly friable conductive ink.

According to one aspect of the invention, at least one of the first and second clamping portions comprises a contact segment making contact with the carrier layer.

According to one aspect of the invention:
an electrically conductive track is placed on the first face of the carrier layer,
the first clamping portion comprises a contact segment making contact with this electrically conductive track, and
the second clamping portion comprises a contact segment making contact with the carrier layer.

According to one aspect of the invention:
an electrically conductive track is placed on the second face of the carrier layer, and the second clamping portion comprises a contact segment making contact with this electrically conductive track.

According to one aspect of the invention, the carrier layer comprises a first carrier layer on which is placed a first electrically conductive track and a second carrier layer on which is placed a second electrically conductive track.

The first and second electrically conductive tracks then form a unitary single-part assembly.

Optionally, an additional layer is placed between the first carrier layer and the second carrier layer.

Preferably, the additional layer 6 has a stiffness greater than that of the first and second carrier layers 31a, 31b.

According to one aspect of the invention, the assembly formed by the first and second clamping portions is shaped like a hairpin, the connector comprising a plurality of sets of first and second clamping portions, the plurality of pins defining a plurality of contact segments making contact with at least one electrically conductive track, these contact segments being regularly distributed over the width of the electrically conductive strip. The width of the electrically conductive strip is defined parallel to the plane of extension of this strip and perpendicular to the longitudinal axis.

The use of a plurality of pins makes it possible both to increase the area of electrical contact and to ensure effective clamping of the electrically conductive strip.

According to one aspect of the invention, at least one of the first and second clamping portions takes the form of a substantially parallelepipedal flexible blade, and the at least one of the first and second clamping portions has an edge intended to face the electrically conductive strip parallel to the longitudinal axis, this edge having a substantially curved profile over at least one portion of the length of the blade.

According to a first variant, the first clamping portion and second clamping portion each have an edge intended to face the electrically conductive strip parallel to the longitudinal axis, this edge having a substantially curved profile over at least one portion of the length of the blade.

According to a second variant:
the first clamping portion has an edge intended to face the electrically conductive strip parallel to the longitudinal axis, this edge having a curved profile over at least one portion of the length of the blade associated with this first portion, and
the second clamping portion has an edge intended to face the electrically conductive strip parallel to the longitudinal axis, this edge having a substantially flat profile over the entire length of the blade associated with this second portion.

According to one aspect of the invention, the assembly formed by the first and second clamping portions takes the form of a clip or jaw.

According to one aspect of the invention, at least one of the contact segments comprises a corrugation that protrudes toward the clamping region and that is able to deform elastically during insertion or removal of the electrically conductive strip into or out of the clamping region.

Preferably, the first and second clamping portions comprise a plurality of contact segments configured to be distributed over the length of the electrically conductive strip, each of these contact segments comprising a corrugation that protrudes toward the clamping region and that is able to elastically deform during insertion or removal of the electrically conductive strip into or out of the clamping region. In this configuration, there are therefore a plurality of corrugations.

The corrugations are preferably regularly distributed over the length of each clamping portion, this length being measured along the longitudinal axis. It is advantageous to place each corrugation of a contact segment of the first clamping portion facing a corrugation of a contact segment of the second clamping portion, so as to better distribute the clamping forces exerted on the electrically conductive strip.

These corrugations result in an alternation of convex and concave segments along each clamping portion, and separate from each other the first and second clamping portions outside the clamping region. In other words, the assembly formed by the first and second clamping portions has a flared profile when observed in a plane perpendicular to the plane of extension of the electrically conductive strip and passing through the longitudinal axis. This flared profile facilitates insertion of the electrically conductive strip when it is inserted into the clamping region.

According to one aspect of the invention, the one or more corrugations define contact segments each having a substantially rectilinear or substantially curvilinear profile over the width of the electrically conductive strip.

According to one aspect of the invention, the first and/or second clamping portions cover at least 90% of the width of the associated electrically conductive track, and preferably 100% of its width.

This configuration improves the distribution of the electric current over the width of the conductive track. The risk of formation of hot spots is moreover reduced.

According to one aspect of the invention, the first and second clamping portions are configured to clamp a border of the electrically conductive strip.

According to one aspect of the invention, the first and second clamping portions are connected by a junction segment comprising an elastic return means configured to hold the first and second clamping portions in a stressed position for clamping the electrically conductive strip.

The elastic return means can comprise a coil spring. Opposite ends of the spring are attached to the first clamping portion and the second clamping portion, respectively.

It is advantageous for the first and second clamping portions to form a single part.

According to one embodiment, the first and second clamping portions are made of an electrically conductive material, such as for example copper, aluminum or any alloy making it possible to guarantee effective clamping, a good conductivity, a good ductility, and a good resistance to chemical and/or electrical corrosion. The alloy can be based on copper, aluminum, tin, lead, chromium.

According to another embodiment, the first clamping portion is made of an electrically conductive material whereas the second clamping portion is made of an electrically insulating material, such as a thermoplastic for example.

The first clamping portion can be at least partially embedded in the electrically insulating material from which the second clamping portion is formed. It is possible to overmold the first and second clamping portions.

Preferably, the second clamping portion comprises a first holding segment and a second holding segment that are securely fastened to each other, the first holding segment being configured to make contact with the second face of the carrier layer, and the second holding segment being configured to hold the first portion in contact with the electrically conductive track placed on the first face of the carrier layer. It would be equivalent to place the electrically conductive track on the second face of the carrier layer and to hold the first clamping portion in contact with the electrically conductive track using one of the holding segments described above.

The first clamping portion is for example at least partially embedded in the electrically insulating material from which the second holding segment is formed.

Optionally, the connector can comprise an additional portion made of electrically conductive material intended to make contact with an electrically conductive track placed on the second face of the carrier layer, the electrically conductive track for example being connected to the electrically conductive track placed on the first face of the carrier layer. The additional portion made of electrically conductive material is for example at least partially embedded in the electrically insulating material from which the first holding segment is made.

According to one aspect of the invention, the electrical connector comprises a connecting member that protrudes from one of the edges of the first clamping portion and/or of the second clamping portion, said connecting member being configured to ensure connection to a power supplying network, of a motor vehicle for example.

The connecting member can be made of the same material as and integrally formed with the first clamping portion and/or second clamping portion.

The present invention also relates to an assembly for a heating structure intended to be installed in a vehicle interior, this assembly comprising:
an electrically conductive strip comprising a carrier layer, which has a first face and a second face opposite the first face, and at least one electrically conductive track placed on the first face and/or the second face of the carrier layer,
an electrical connector such as defined above, the first and second clamping portions of which define a clamping region for clamping the electrically conductive strip.

According to one aspect of the assembly according to the invention, an additional layer is placed between the carrier layer and the one of the first and second clamping portions making contact with the carrier layer, said additional layer having a stiffness greater than that of the carrier layer. The function of the additional layer is to locally stiffen the electrically conductive strip in at least the region of the strip making contact with the connector.

Due to its stiffness being greater than that of the carrier layer, this additional layer attenuates the movements of the electrically conductive strip and limits the risk of breakage and cracking of the strip.

This additional layer is made of an electrically insulating material, for example a thermoplastic or textile, of stiffness greater than that of the textile of the carrier layer.

This additional layer extends over at least one portion of the length of the electrically conductive track. Preferably, it extends over a length of the electrically conductive track corresponding at least to the length of the connector measured parallel to the longitudinal axis when said connector is connected to the electrically conductive strip.

Also preferably, this additional layer juts out from the leading edge of the connector, this leading edge being defined perpendicular to the longitudinal axis and facing the electrically conductive track.

It is for example fastened to the carrier layer by adhesive bonding, or overmolded.

According to another aspect of the invention, this assembly comprises an electrically conductive track placed on the first face of the carrier layer and an electrically conductive track placed on the second face of the carrier layer, said tracks being connected to each other.

Said electrically conductive tracks for example form a unitary assembly.

According to one aspect of the invention, the electrically conductive strip is a conductive strip for a heating structure, for example a radiant panel of high area-to-volume ratio intended to be installed in an interior, especially a motor-vehicle interior.

The present invention also relates to a heating structure, such as a radiant panel for installation within a motor vehicle interior, said heating structure comprising a heating structure assembly as previously described.

According to one aspect of the invention, the heating structure further comprises a resistive layer arranged to produce heat release when an electric current is passed through the resistive layer, the heating structure further comprising an electrode array having a plurality of contact electrodes (or secondary electrodes) arranged to be in electrical contact with the resistive layer to cause electric current to flow in the resistive layer.

According to one aspect of the invention, the electrode array comprises distribution electrodes (so-called main electrodes) arranged to conduct electrical current from an electrical source to the contact electrodes, with a plurality of contact electrodes connecting to a single distribution electrode.

According to one aspect of the invention, at least one of said distribution electrodes comprises said electrically conductive track disposed on the first side and/or the second side of the support layer.

In particular, a first distribution electrode comprises an electrically conductive track arranged on the first side of the support layer and a second distribution electrode comprises an electrically conductive track arranged on the second side of the support layer.

Alternatively, a single distribution electrode comprises both an electrically conductive track disposed on the first side of the support layer and a second electrically conductive track disposed on the second side of the support layer, wherein the two tracks can be connected to each other.

According to one aspect of the invention, the resistive layer associated with the group of contact electrodes is a continuous layer, or alternatively comprises a plurality of discrete resistive elements forming that layer.

According to one aspect of the invention, the resistive layer is carried by the support layer of the electrically conductive strip.

The resistive layer can be deposited on the support layer by screen-printing.

The resistive layer can be made of a partially resistive conductive material, for example paint comprising carbon particles and/or metal particles.

### BRIEF DESCRIPTION OF THE DRAWINGS

Further features, details and advantages of the invention will emerge upon reading the description given below by way of indication with reference to the drawings, in which:

FIG. 1 is a schematic representation seen in profile of an electrically conductive strip and of an electrical connector according to a first embodiment;

FIG. 2 is a schematic representation seen from above of the electrically conductive strip and of the electrical connector of FIG. 1;

FIG. 3 is a schematic representation seen in profile of an electrically conductive strip and of an electrical connector according to one variant of the first embodiment of FIG. 1;

FIG. 4 is a schematic representation seen in profile of an electrically conductive strip and of an electrical connector according to another variant of the first embodiment of FIG. 1;

FIG. 5 is a schematic representation seen in profile of an electrically conductive strip and of an electrical connector according to another variant of the first embodiment of FIG. 1;

FIG. 6 is a schematic representation seen from above of the electrical connector of FIG. 1;

FIG. 7 is a schematic representation seen in profile of an electrically conductive strip and of an electrical connector according to a second embodiment;

FIG. 8 is a schematic representation seen in profile of an electrically conductive strip and of an electrical connector according to one variant of the second embodiment;

FIG. 9 is a schematic representation seen in profile of an electrically conductive strip and of an electrical connector according to one variant of the second embodiment;

FIG. 10 is a schematic representation seen in profile of an electrically conductive strip and of an electrical connector according to one variant of the second embodiment; and

FIG. 11 is a schematic representation seen in profile of an electrically conductive strip and of an electrical connector according to one embodiment of the invention.

The features, variants and different embodiments of the invention can be associated with one another, in various combinations, provided that they are not mutually incompatible or exclusive. It is possible, especially, to imagine variants of the invention comprising only a selection of the features described below, in isolation from the other described features, if this selection of features is sufficient to confer a technical advantage or to distinguish the invention from the prior art.

In particular, all of the variants and all of the embodiments described can be combined with one another if there is no technical reason preventing this combination.

It should be noted that the figures illustrate the invention in detail with a view to the implementation of the invention. Said figures can of course serve to better define the invention, where appropriate.

In the figures, elements that are common to multiple figures retain the same reference.

In the present invention, certain elements can be indexed (such as for example first element or second element, etc.). Unless stated otherwise, it is a question of simple indexing, to differentiate between and name elements that are similar but not identical. This indexing does not imply priority of one element with respect to another and such denominations can easily be interchanged without departing from the scope of the present description.

### DETAILED DESCRIPTION OF THE INVENTION

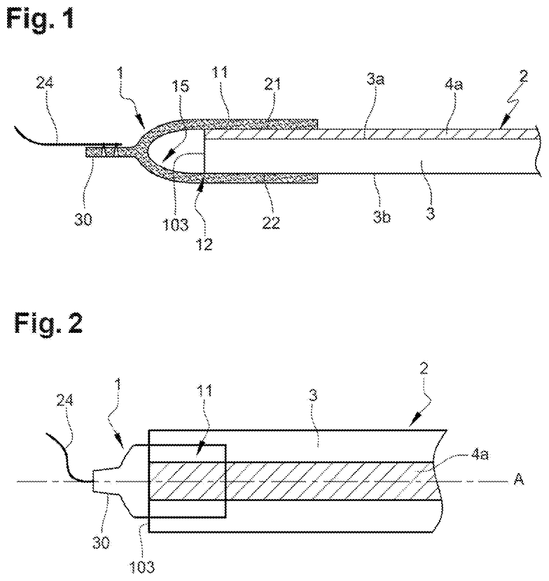

FIG. 1 illustrates a profile view of an electrically conductive strip 2 and of an electrical connector 1. The electrically conductive strip 2 extends along a longitudinal axis A (especially shown in FIG. 2) and comprises:
a carrier layer 3 having a first face 3a and a second face 3b opposite the first face,
an electrically conductive track 4a placed on the first face 3a of the carrier layer 3.

The carrier layer 3 can be made of an electrically non-conductive material. The carrier layer 3 can be made of pliable material, capable of taking a predetermined form through deformation, this carrier especially being stretchable. The material of the carrier can, non-limitingly, be chosen from: a thermoplastic, a non-woven textile, a fabric, or even a stretchable textile or a stretchable knit.

When the carrier layer is made of fabric, the stretchable character can be obtained either through the arrangement of the woven structure, namely through the weaving technique, or through the intrinsic stretchability of the threads used to weave the fabric.

The non-woven fabric can comprise a blend of polypropylene fibers and/or polyester fibers. Other fibers can be used, for example natural fibers.

When the carrier layer is made of thermoplastic, this material is preferably chosen from the following list: a polycarbonate and/or a polyethylene terephthalate and/or a polymethyl methacrylate and/or a polybutylene terephthalate and/or a polyamide and/or a polyolefin and/or a copolymer and/or an elastomer.

The advantage of a soft and flexible material is that it makes it easier to integrate the electrically conductive strip 2 into various types of surfaces, especially within a vehicle interior. Advantageously, an electrically conductive strip comprising a soft and flexible carrier layer conforms more easily, by conformal contact, to the contours of interior components, for example an armrest, a dashboard, a steering wheel or any other component likely to accommodate such an electrically conductive strip.

The carrier layer 3 can have a thickness less than or equal to 2 mm. Preferably, the carrier layer 3 has a thickness comprised between 5 μm and 2 mm, and preferably comprised between 50 μm and 2 mm.

The electrically conductive strip 2 can be a conductive strip for a heating structure, such as a radiant panel of high area-to-volume ratio, in order especially to provide heating within a vehicle interior, especially a motor-vehicle interior. This electrically conductive strip 2 can especially be configured to achieve high power levels, i.e. power levels higher than or equal to 500 W/m² for example. The electrically conductive strip 2 can especially be configured to carry currents of the order of 15 A and to hold a voltage of the order of 12 V, or even 48 V, depending on the supply voltage within the motor vehicle.

For application to heating using a radiant panel of high area-to-volume ratio, an electrically conductive track 4a composed of an electrically conductive ink placed on the first face 3a of the carrier layer 3 is advantageously used. This electrically conductive track is commonly called the bus bar or main electrode, and it is intended to supply electric current to the electrically conductive strip 2.

The electrically conductive ink can be filled with conductive particles, and especially with particles of silver, of copper and/or of an alloy such as nichrome.

The electrically conductive track 4a can be deposited on the carrier layer 3, especially by screen printing or electrodeposition. It can have a thickness less than or equal to 200 μm, and especially less than or equal to 60 μm.

The electrical connector 1 comprises first and second clamping portions (11 and 12, respectively) that are securely fastened to each other and that define a clamping region 15 for clamping the electrically conductive strip 2. The first clamping portion 11 comprises a contact segment 21 making contact with the electrically conductive track 4a, while the second clamping portion 12 comprises a contact segment 22 making contact with the carrier layer 3.

The first clamping portion 11 and the second clamping portion 12 are made of an electrically conductive material, for example copper, aluminum or any alloy making it possible to guarantee effective clamping, a good conductivity, a good ductility, and a good resistance to chemical and/or electrical corrosion.

The first and second clamping portions 11, 12 form a single part.

As shown in FIG. 1, the first and second clamping portions 11, 12 are configured to clamp the electrically conductive strip 2 and make electrical contact between the electrically conductive track 4a and the first clamping portion 11.

The electrical connector 1 comprises a connecting member 30 that protrudes from one edge of the first clamping portion 11 and second clamping portion 12. This connecting member 30 is configured to ensure connection to a power supplying network, of a motor vehicle for example. This connecting member 30 makes it possible to make electrical connection with, for example, an electric wire 24 crimped directly onto this connecting member. It also makes it possible to connect the electrical connector 1 to a complementary plug that is, for example, crimped onto a wire, a metal tongue or an electrical cable. Preferably, the connecting member 30 is made of the same material as and integrally formed with the first clamping portion 11 and the second clamping portion 12. In the case where the electrical wire is crimped onto the connecting member, a plastic casing (not shown) can be added to ensure electrical insulation.

The electrical connector 1 preferably forms a single part, and to this end is for example produced by stamping or cutting. The first and second clamping portions 11, 12 and the connecting member 30 can thus all be formed in one and the same manufacturing step. As can be seen in FIG. 2, the first portion 11 takes the form of a substantially parallelepipedal flexible blade. The second portion 12 (not shown in FIG. 2) also takes this form. The first and second clamping portions 11, 12 are configured to clamp a border 103 of the electrically conductive strip 2. Advantageously, the first clamping portion 11 covers the entire width of the electrically conductive track 4a. Thus, electric current is better distributed over the width of the electrically conductive track and the risk of formation of hot spots is reduced.

According to the examples illustrated in FIGS. 1 and 4, the first and second clamping portions (11 and 12, respectively), which are blade-shaped, each have an edge (101 and 102, respectively, as shown in FIG. 6) facing the electrically conductive strip 2, parallel to the longitudinal axis A. Each of these edges 101, 102 has a substantially curved profile over one portion of the length of each flexible blade when the connector is observed in the plane of FIG. 4.

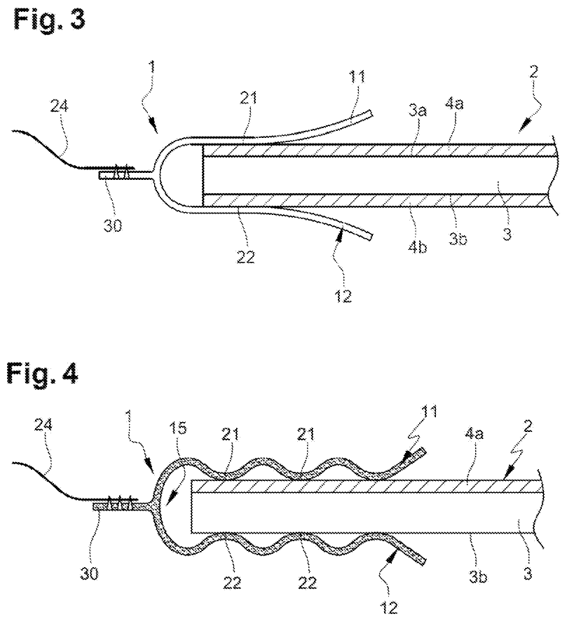

According to one variant of the embodiment of FIG. 1, as illustrated in FIG. 3, an additional electrically conductive track 4b is placed on the second face 3b of the carrier layer 3. The second clamping portion 12 comprises a contact segment 22 making contact with this electrically conductive track 4b.

The two electrically conductive tracks 4a, 4b make it possible to ensure double electrical contact via the electrical connector 1, by involving both the first and second faces 3a, 3b of the carrier layer 3. In this specific case, it is essential for the electrically conductive tracks 4a, 4b to be arranged so as to make electrical contact with each other. For example, this electrical contact can be ensured by means of a secondary electrically conductive track placed at distance from the electrical connector 1, or more generally by any suitable electrically conductive element.

FIG. 11 illustrates an alternative way of obtaining a heating-structure assembly comprising an electrically conductive strip 2 and an electrical connector 1 the first and second clamping portions 11, 12 of which define a clamping region 15 for clamping this strip, and in which the electrically conductive strip 2 comprises a carrier layer 3 and a set of electrically conductive tracks 4a, 4b placed on a first face 3a and a second face 3b, opposite the first face 3a, of the carrier layer 3, respectively.

In particular, the carrier layer 3 comprises a first carrier layer 31a and a second carrier layer 31b that are securely fastened to each other and that are placed facing each other. This particular arrangement of the electrically conductive tracks 4a, 4b is for example obtained at the end of a step of folding an electrically conductive strip 2 comprising a carrier layer 3 on which an electrically conductive track is placed. The direction in which said strip is folded must be chosen such that the electrically conductive tracks 4a, 4b are arranged, after the electrically conductive strip 2 has been folded, on the external faces (i.e. the first and second faces 3a, 3b shown in FIG. 11) of the carrier layer 3. Folding can be carried out as required depending on the width or length of the electrically conductive strip 2. In the example of FIG. 11, the electrically conductive strip 2 has been folded perpendicular to the longitudinal axis A. The fold in the electrically conductive strip 2 therefore extends the width of the strip.

The folding step described above makes it possible to obtain a carrier layer 3 comprising a first carrier layer 31a on which is placed a first electrically conductive track 4a, and a second carrier layer 31b on which is placed a second electrically conductive track 4b. In this configuration, the electrically conductive tracks 4a, 4b form a unitary single-part assembly.

In the assembly illustrated in FIG. 11, the electrical connector 1 comprises a first clamping portion 11 and a second clamping portion 12 that are securely fastened to each other and that define a clamping region 15 for clamping the electrically conductive strip 2. The first and second clamping portions 11, 12 made of electrically conductive material clamp the electrically conductive strip 2 and make electrical contact with the electrically conductive track 4a and with the electrically conductive track 4b, respectively.

Optionally, provision can be made to place an additional layer 6 between the first carrier layer 31a and the second carrier layer 31b. Preferably, the additional layer 6 has a stiffness greater than that of the first and second carrier layers 31a, 31b. This advantageously limits the risk of formation of cracks and tears in the electrically conductive strip during fitting of the electrical connector.

The additional layer 6 can take the form of a mechanically reinforcing plastic film. It can also be an integral portion of a plastic part of a holding casing exterior to the assembly formed by the electrical connector 1 and the electrically conductive strip 2.

It will be sought to limit the thickness of the additional layer 6 so as not to adversely affect the haptics of the electrically conductive strip 2. For example, the additional layer has a thickness of less than 200 μm.

The additional layer 6 is for example fastened to the carrier layer 3 by adhesive bonding, or overmolded.

Optionally, provision can be made to provide holding parts 9 for the assembly made up of the electrical connector 1 and the electrically conductive strip 2.

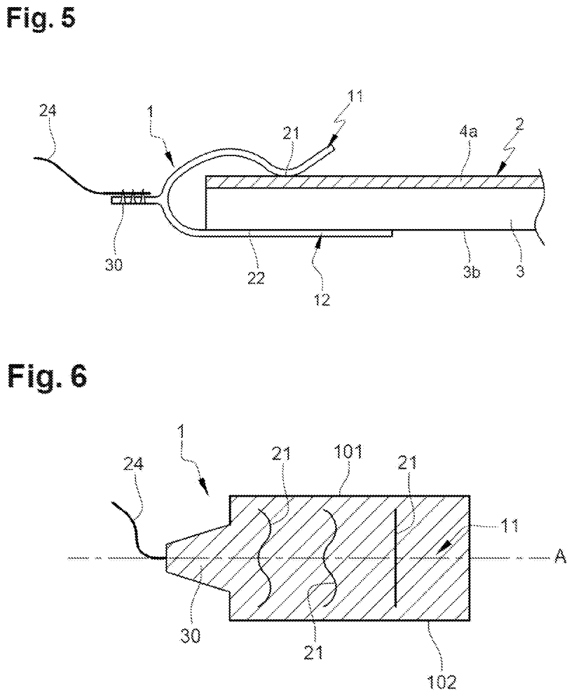

FIG. 5 illustrates a variant of the embodiment of FIG. 1, in which:
the first clamping portion 11 has an edge 101 intended to face the electrically conductive strip 2 parallel to the longitudinal axis A, this edge having a curved profile over at least one portion of the length of the blade associated with this first portion 11, and
the second clamping portion 12 has an edge 102 intended to face the electrically conductive strip 2 parallel to the longitudinal axis A, this edge having a substantially flat profile over the entire length of the blade associated with this second portion 12.

To guarantee effective clamping of the electrically conductive strip, while ensuring electrical connection, it can be envisioned for the first and second clamping portions to take various forms. FIG. 4 is an illustration of this.

As shown in FIG. 4, the first clamping portion 11 comprises a plurality of contact segments 21 and the second clamping portion 12 comprises a plurality of contact segments 22. These contact segments 21, 22 are distributed over the length of the electrically conductive strip. Each of these contact segments comprises a corrugation that protrudes toward the clamping region 15 and that is able to deform elastically during insertion or removal of the electrically conductive strip 2 into or out of the clamping region 15.

The corrugations are regularly distributed over the length of each first and second clamping portion, this length being measured along the longitudinal axis A. It is advantageous to place each corrugation of a contact segment of the first clamping portion facing a corrugation of a contact segment of the second clamping portion, so as to better distribute the clamping forces exerted on the electrically conductive strip 2.

These corrugations result in an alternation of convex and concave segments along each clamping portion of the connector, and separate from each other the first and second clamping portions 11, 12 outside the clamping region, this particularly being shown in FIG. 4. In other words, the assembly formed by the first and second clamping portions 11, 12 has a flared profile when observed in a plane perpendicular to the plane of extension of the electrically conductive strip 2 and passing through the longitudinal axis A. This flared profile facilitates insertion of the electrically conductive strip 2 into the clamping region 15.

In FIG. 6, which is a representation seen from above of the electrical connector 1 of FIG. 4, the corrugations define two contact segments 21 that have a substantially curvilinear profile and one contact segment 21 that is substantially rectilinear over the width of the electrically conductive strip 2. The curvilinear shape of the contact segments makes it possible not to create lines of breakage of current flow. This shape also reduces the risk of tearing of the electrically conductive strip.

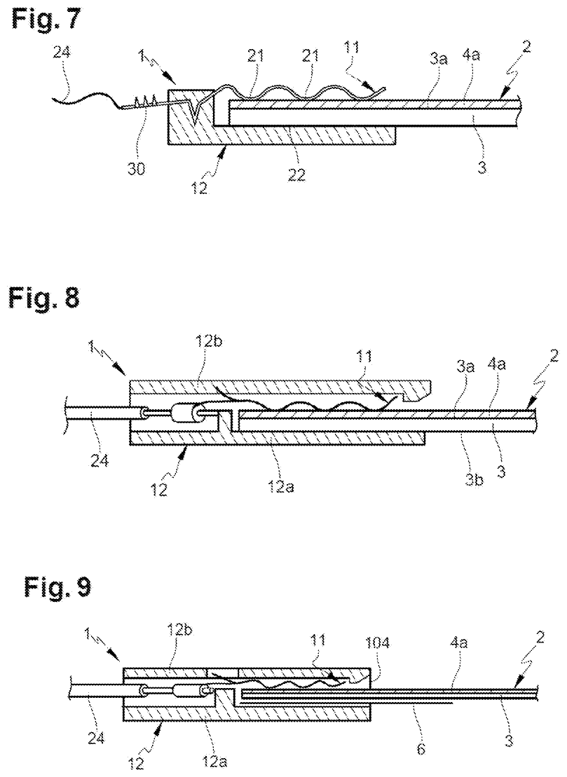

FIG. 7 schematically shows a profile view of an electrically conductive strip 2 and of an electrical connector 1 according to a second embodiment of the invention. According to this example, the first clamping portion 11 is made of an electrically conductive material, aluminum for example, whereas the second clamping portion 12 is made of an electrically insulating material, such as a thermoplastic for example.

The first clamping portion 11 is here partially embedded in the electrically insulating material from which the second clamping portion 12 is formed. In particular, the end of the first clamping portion 11 that does not make contact with the electrically conductive track 4a is embedded in the electrically insulating material. The two clamping portions can be overmolded.

According to one preferred embodiment illustrated in FIG. 8, the second clamping portion 12 comprises a first holding segment 12a and a second holding segment 12b that are securely fastened to each other. The first holding segment 12a makes contact with the second face 3b of the carrier layer 3, and the second holding segment 12b holds the first clamping portion 11 electrically in contact with the track 4a placed on the first face 3a of the carrier layer 3.

The first clamping portion 11, and in particular one of its ends not making contact with the electrically conductive track 4a, is partially embedded in the electrically insulating material from which the second holding segment 12b is formed.

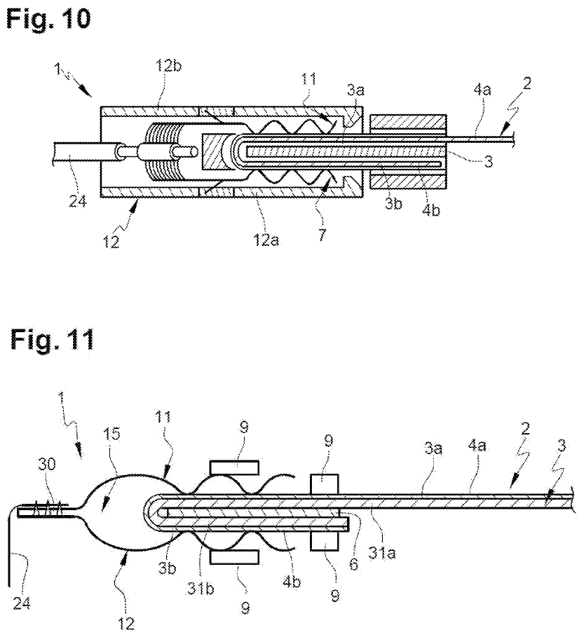

According to one variant shown in FIG. 10, the electrical connector 1 of the assembly illustrated in FIG. 8 comprises an additional portion 7 made of electrically conductive material that makes contact with an electrically conductive track 4b placed on the second face 3b of the carrier layer 3. The electrically conductive track 4b is connected to the electrically conductive track 4a placed on the first face 3a of the carrier layer 3. The additional portion 7 made of electrically conductive material is partially embedded in the electrically insulating material from which the first holding segment 12a is made. The electrically conductive tracks 4a, 4b here form a unitary assembly.

In the configuration illustrated in FIG. 8, a border of the carrier layer 3 is covered by a segment of electrically conductive track. In other words, the unitary assembly of electrically conductive tracks 4a, 4b forms a fold which covers said border. The assembly of electrically conductive tracks 4a, 4b can be held around the carrier layer by means of a clamping ring (not shown).

With the aim of limiting the risk of cracks forming in the electrically conductive strip, in particular when the carrier layer is of small thickness and made of a fragile, pliable material, one solution is to place an additional layer 6 between the carrier layer 3 and the clamping portion making contact with the carrier layer 3. In the example illustrated in FIG. 9, the additional layer 6 is placed between the second holding segment 12a and the carrier layer 3.

Preferably, the additional layer 6 has a stiffness greater than that of the carrier layer 3. It is for example made of an electrically insulating material, for example of a rigid thermoplastic or textile. Due to its stiffness being greater than that of the carrier layer, it attenuates the movements of the electrically conductive strip 2 and limits the risk of cracking and tearing. The function of the additional layer 6 is also to stiffen the electrically conductive track.

The additional layer 6 is for example fastened to the carrier layer 3 by adhesive bonding, or overmolded.

It will be sought to limit the thickness of the additional layer 6 so as not to adversely affect the haptics of the electrically conductive strip 2. For example, the additional layer has a thickness of less than 200 μm.

This additional layer can extend over at least one portion of the length of the electrically conductive track. Preferably, it extends over a length of the electrically conductive track corresponding at least to the length of the electrical connector measured parallel to the longitudinal axis A when the connector is connected to the electrically conductive strip. Also preferably, this additional layer juts out from the leading edge 104 of the connector, this leading edge being defined perpendicular to the longitudinal axis A and facing the electrically conductive track.

What is claimed is:

1. An assembly comprising:
an electrically conductive strip extending along a longitudinal axis, including
a first carrier layer having a first face and a second face opposite the first face;
a first electrically conductive track placed on the first face or the second face of the first carrier layer,
an electrical connector with a first clamping portion and a second clamping portion that are securely fastened to each other and that define a clamping region for clamping the electrically conductive strip, wherein the first and second clamping portions clamp the electrically conductive strip,
wherein at least one of the first and second clamping portions includes first contact segment making electrical contact with the first electrically conductive track.

2. The assembly as claimed in claim 1, wherein:
the first electrically conductive track is placed on the first face of the first carrier layer,
the first clamping portion includes the first contact segment making contact with the first electrically conductive track,
the second clamping portion includes a second contact segment making contact with the first carrier layer.

3. The assembly as claimed in claim 1, wherein at least one of the first and second clamping portions takes form of a substantially parallelepipedal flexible blade, and the at least one of the first and second clamping portions has an edge facing the electrically conductive strip parallel to the longitudinal axis, the edge having a substantially curved profile over at least one portion of the length of the blade along the longitudinal axis.

4. The assembly as claimed in claim 2, wherein at least one of the first and second contact segments includes a corrugation that protrudes toward the clamping region and that is able to deform elastically during insertion or removal of the electrically conductive strip into or out of the clamping region.

5. The assembly as claimed in claim 1, wherein the first and second clamping portions are made of an electrically conductive material.

6. The assembly as claimed in claim 1, wherein the first clamping portion is made of an electrically conductive material whereas the second clamping portion is made of an electrically insulating material.

7. The assembly as claimed in claim 1, wherein the second clamping portion includes a first holding segment and a second holding segment that are securely fastened to each other, the first holding segment making contact with the second face of the first carrier layer, and the second holding segment being configured to hold the first portion in contact electrically with the first electrically conductive track placed on the first face of the first carrier layer.

8. The assembly as claimed in claim 1, wherein the electrically conductive strip includes a second electrically conductive track, with the electrical connector including an additional portion made of electrically conductive material intended to make contact with the second electrically conductive track placed on the second face of the first carrier layer, the second electrically conductive track being connected to the first electrically conductive track placed on the first face of the first carrier layer.

9. The assembly as claimed in claim 1, wherein the first clamping portion is at least partially embedded in the electrically insulating material from which the second clamping portion is formed.

10. (canceled)

11. The assembly as claimed in claim 1, further comprising an additional layer placed between the first carrier layer and the one of the first and second clamping portions making contact with the first carrier layer, the additional layer having a stiffness greater than that of the first carrier layer.

12. The assembly as claimed in claim 1, wherein the electrically conductive strip includes a second carrier layer that is securely fastened to the first carrier layer and placed so that they face each other, and a second electrically conductive track, with the first electrically conductive track being placed on the first carrier layer and the second electrically conductive track being placed on the second carrier layer, the first and second clamping portions of the electrical connector making electrical contact with the first and second electrically conductive tracks, respectively.

13. The assembly as claimed in claim 12, wherein the first and second electrically conductive tracks form a unitary single-part assembly.

14. The assembly as claimed in claim 12, further comprising an additional layer arranged between the first carrier layer and the second carrier layer.

15. A radiant panel for a motor vehicle interior, comprising an assembly including:
an electrically conductive strip extending along a longitudinal axis, including
a first carrier layer having a first face and a second face opposite the first face;
a first electrically conductive track placed on the first face or the second face of the first carrier layer;
an electrical connector with a first clamping portion and a second clamping portion that are securely fastened to each other and that define a clamping region for clamping the electrically conductive strip,
wherein the first and second clamping portions clamp the electrically conductive strip,
wherein at least one of the first and second clamping portions includes a first contact segment making electrical contact with the first electrically conductive track.

16. The assembly as claimed in claim 12, further comprising an additional layer arranged between the first carrier layer and the second carrier layer and having a stiffness greater than that of the first carrier layer and the second carrier layer.

17. An assembly comprising:
an electrically conductive strip extending along a longitudinal axis, including
a first carrier layer having a first face and a second face opposite the first face;
a first electrically conductive track placed on the first face and the second face of the first carrier layer;
an electrical connector with a first clamping portion and a second clamping portion that are securely fastened to each other and that define a clamping region for clamping the electrically conductive strip, wherein the first and second clamping portions clamp the electrically conductive strip,
wherein at least one of the first and second clamping portions includes a first contact segment making electrical contact with the first electrically conductive track.
